(19) United States
(12) Patent Application Publication
(10) Pub. No.: US 2010/0014777 A1
(43) Pub. Date: Jan. 21, 2010

(54) SYSTEM AND METHOD FOR IMPROVING THE QUALITY OF COMPRESSED VIDEO SIGNALS BY SMOOTHING THE ENTIRE FRAME AND OVERLAYING PRESERVED DETAIL

(75) Inventors: Leonard T. Bruton, Calgary (CA); Greg Lancaster, Calgary (CA); Matt Sherwood, Okotoks (CA); Danny D. Lowe, Calgary (CA)

Correspondence Address: FULBRIGHT & JAWORSKI L.L.P, 2200 ROSS AVENUE, SUITE 2800, DALLAS, TX, 75201-2784, US

(73) Assignee: Headplay (Barbados) Inc.

(21) Appl. No.: 12/176,372

(22) Filed: Jul. 19, 2008

(51) Int. Cl. G06K 9/40; H04N 7/12

(52) U.S. Cl. 382/275; 375/240.27; 382/250; 375/E07.076

(57) ABSTRACT

Systems and methods are disclosed for improving the quality of compressed digital video signals by separating the video signals into Deblock and Detail regions and, by smoothing the entire frame, and then by over-writing each smoothed frame by a preserved Detail region of the frame. The Detail region may be computed only in Key Frames after which it may be employed in adjacent frames in order to improve computational efficiency. This improvement is enhanced by computing an Expanded Detailed Region in Key Frames. The concept of employing a smooth Canvas Image onto which the Detail image is overwritten is analogous to an artist first painting the entire picture with an undetailed Canvas (usually using a broad large brush) and then over-painting that Canvas with the required detail (usually using a small fine brush).

### CROSS-REFERENCE TO RELATED APPLICATIONS

This application is related to concurrently filed, co-pending, commonly owned patent applications SYSTEMS AND METHODS FOR IMPROVING THE QUALITY OF COMPRESSED VIDEO SIGNALS BY SMOOTHING BLOCK ARTIFACTS, U.S. patent application Ser. No. ______, Attorney Docket No. 54729/P010US/10806075; and SYSTEMS AND METHODS FOR HIGHLY EFFICIENT VIDEO COMPRESSION USING SELECTIVE RETENTION OF RELEVANT VISUAL DETAILS, U.S. patent application Ser. No. ______, Attorney Docket No. 54729/P012US/10808779, which applications are hereby incorporated by reference herein.

### TECHNICAL FIELD

This disclosure relates to digital video signals and more specifically to systems and methods for improving the quality of compressed digital video signals by separating the video signals into Deblock and Detail regions and, by smoothing the entire frame, and then by over-writing each smoothed frame by a preserved Detail region of the frame.

### BACKGROUND OF THE INVENTION

It is well-known that video signals are represented by large amounts of digital data, relative to the amount of digital data required to represent text information or audio signals. Digital video signals consequently occupy relatively large bandwidths when transmitted at high bit rates and especially when these bit rates must correspond to the real-time digital video signals demanded by video display devices.

In particular, the simultaneous transmission and reception of a large number of distinct video signals, over such communications channels as cable or fiber, is often achieved by frequency-multiplexing or time-multiplexing these video signals in ways that share the available bandwidths in the various communication channels.

Digitized video data are typically embedded with the audio and other data in formatted media files according to internationally agreed formatting standards (e.g. MPEG2, MPEG4, H264). Such files are typically distributed and multiplexed over the Internet and stored separately in the digital memories of computers, cell phones, digital video recorders and on compact discs (CDs) and digital video discs DVDs). Many of these devices are physically and indistinguishably merging into single devices.

In the process of creating formatted media files, the file data is subjected to various levels and types of digital compression in order to reduce the amount of digital data required for their representation, thereby reducing the memory storage requirement as well as the bandwidth required for their faithful simultaneous transmission when multiplexed with multiple other video files.

The Internet provides an especially complex example of the delivery of video data in which video files are multiplexed in many different ways and over many different channels (i.e. paths) during their downloaded transmission from the centralized server to the end user. However, in virtually all cases, it is desirable that, for a given original digital video source and a given quality of the end user's received and displayed video, the resultant video file be compressed to the smallest possible size.

Formatted video files might represent a complete digitized movie. Movie files may be downloaded ‘on demand’ for immediate display and viewing in real-time or for storage in end-user recording devices, such as digital video recorders, for later viewing in real-time.

Compression of the video component of these video files therefore not only conserves bandwidth, for the purposes of transmission, but it also reduces the overall memory required to store such movie files.

At the receiver end of the abovementioned communication channels, single-user computing and storage devices are typically employed. Currently-distinct examples of such single-user devices are the personal computer and the digital set top box, either or both of which are typically output-connected to the end-user's video display device (e.g. TV) and input-connected, either directly or indirectly, to a wired copper distribution cable line (i.e. Cable TV). Typically, this cable simultaneously carries hundreds of real-time multiplexed digital video signals and is often input-connected to an optical fiber cable that carries the terrestrial video signals from a local distributor of video programming. End-user satellite dishes are also used to receive broadcast video signals. Whether the end-user employs video signals that are delivered via terrestrial cable or satellite, end-user digital set top boxes, or their equivalents, are typically used to receive digital video signals and to select the particular video signal that is to be viewed (i.e the so-called TV Channel or TV Program). These transmitted digital video signals are often in compressed digital formats and therefore must be uncompressed in real-time after reception by the end-user.

Most methods of video compression reduce the amount of digital video data by retaining only a digital approximation of the original uncompressed video signal. Consequently, there exists a measurable difference between the original video signal prior to compression and the uncompressed video signal. This difference is defined as the video distortion. For a given method of video compression, the level of video distortion almost always becomes larger as the amount of data in the compressed video data is reduced by choosing different parameters for those methods. That is, video distortion tends to increase with increasing levels of compression.

As the level of video compression is increased, the video distortion eventually becomes visible to the human vision system (HVS) and eventually this distortion becomes visibly-objectionable to the typical viewer of the real-time video on the chosen display device. The video distortion is observed as so-called video artifacts. A video artifact is observed video content that is interpreted by the HVS as not belonging to the original uncompressed video scene.

Methods exist for significantly attenuating visibly-objectionable artifacts from compressed video, either during or after compression. Most of these methods apply only to compression methods that employ the block-based Two-dimensional (2D) Discrete Cosine Transform (DCT) or approximations thereof. In the following, we refer to these methods as DCT-based. In such cases, by far the most visibly-objectionable artifact is the appearance of artifact blocks in the displayed video scene.

Methods exist for attenuating the artifact blocks typically either by searching for the blocks or by requiring a priori knowledge of where they are located in each frame of the video.

The problem of attenuating the appearance of visibly-objectionable artifacts is especially difficult for the widely-occurring case where the video data has been previously compressed and decompressed, perhaps more than once, or where it has been previously re-sized, re-formatted or color re-mixed. For example, video data may have been re-formatted from the NTSC to PAL format or converted from the RGB to the YCrCb format. In such cases, a priori knowledge of the locations of the artifact blocks is almost certainly unknown and therefore methods that depend on this knowledge do not work.

Methods for attenuating the appearance of video artifacts must not add significantly to the overall amount of data required to represent the compressed video data. This constraint is a major design challenge. For example, each of the three colors of each pixel in each frame of the displayed video is typically represented by 8 bits, therefore amounting to 24 bits per colored pixel. For example, if pushed to the limits of compression where visibly-objectionable artifacts are evident, the H264 (DCT-based) video compression standard is capable of achieving compression of video data corresponding at its low end to approximately 1/40th of a bit per pixel. This therefore corresponds to an average compression ratio of better than 40×24=960. Any method for attenuating the video artifacts, at this compression ratio, must add therefore an insignificant number of bits relative to 1/40th of a bit per pixel. Methods are required for attenuating the appearance of block artifacts when the compression ratio is so high that the average number of bits per pixel is typically less than 1/40th of a bit.

For DCT-based and other block-based compression methods, the most serious visibly-objectionable artifacts are in the form of small rectangular blocks that typically vary with time, size and orientation in ways that depend on the local spatial-temporal characteristics of the video scene. In particular, the nature of the artifact blocks depends upon the local motions of objects in the video scene and on the amount of spatial detail that those objects contain. As the compression ratio is increased for a particular video, MPEG-based DCT-based video encoders allocate progressively fewer bits to the so-called quantized basis functions that represent the intensities of the pixels within each block. The number of bits that are allocated in each block is determined on the basis of extensive psycho-visual knowledge about the HVS. For example, the shapes and edges of video objects and the smooth-temporal trajectories of their motions are psycho-visually important and therefore bits must be allocated to ensure their fidelity, as in all MPEG DCT based methods.

As the level of compression increases, and in its goal to retain the above mentioned fidelity, the compression method (in the so-called encoder) eventually allocates a constant (or almost constant) intensity to each block and it is this block-artifact that is usually the most visually objectionable. It is estimated that if artifact blocks differ in relative uniform intensity by greater than 3% from that of their immediate neighboring blocks, then the spatial region containing these blocks is visibly-objectionable. In video scenes that have been heavily-compressed using block-based DCT-type methods, large regions of many frames contain such block artifacts.

### BRIEF SUMMARY OF THE INVENTION

Systems and methods are disclosed for improving the quality of compressed digital video signals by separating the video signals into Deblock and Detail regions, smoothing the entire frame, and then by over-writing each smoothed frame by a preserved Detail region of the frame.

In one embodiment, a method is disclosed for using any suitable method to distinguish and separate a Detail region in an image frame and then spatially smoothing the entire image frame to obtain the corresponding Canvas frame. The separated Detail region of the frame is then combined with the Canvas frame to obtain the corresponding Deblocked image frame.

It is an advantage of the disclosed embodiments that the smoothing operations may be applied to the complete image without concern for the locations of the boundaries that delineate the Detail region. This allows full-image fast smoothing algorithms to be employed to obtain the Canvas frame. These algorithms could, for example, employ fast full-image Fast Fourier Transform (FFT)-based smoothing methods or widely available, highly-optimized FIR or IIR code that serve as low pass smoothing filters.

In one embodiment, the image frame can be spatially down sampled before spatial-smoothing. The down-sampled image frame can then be spatially-smoothed and the resultant image up-sampled to full resolution and combined with the separated Detail portions of the frame.

In another embodiment, the Detail region can be determined in key frames, such as, for example, every fourth frame. If the motions of objects in adjacent frames have sufficiently low speeds, the Detail region may not need to be identified for the adjacent non-key frames and, the Detail region of the nearest key Frame can be overwritten on to the smoothed Canvas frame.

In another embodiment, a ‘growing’ process to the Detail region DET is employed for all key frames such that the Detail region is expanded (or grown) around its boundaries to obtain the Expanded Detail Region.

The foregoing has outlined rather broadly the features and technical advantages of the present invention in order that the detailed description of the invention that follows may be better understood. Additional methods, as well as features and advantages of the invention, will be described hereinafter and form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a typical blocky image frame;

FIG. 2 shows the image of FIG. 1 separated into Deblock regions (shown in black) and Detail regions (shown in white);

FIG. 3 shows one example of the selection of isolated pixels in a frame;

FIG. 4 illustrates a close up of Candidate Pixels C, that are x pixels apart and belong to the Detail region DET because they do not satisfy the Deblock Criteria;

FIG. 5 illustrates one embodiment of a method for assigning a block to the Deblock region by using a nine pixel crossed-mask;

FIG. 6 shows an example of a nine pixel crossed-mask used at a particular location within an image frame;

FIG. 7 shows one embodiment of a method for achieving improved video image quality;

FIGS. 8 and 9 show one embodiment of a method operating according to the concepts discussed herein; and

FIG. 10 shows one embodiment of the use of the concepts discussed herein.

### DETAILED DESCRIPTION OF THE INVENTION

One aspect of the disclosed embodiment is to attenuate the appearance of block artifacts in real-time video signals by identifying a region in each frame of the video signal for deblocking using flatness criteria and discontinuity criteria. Additional gradient criteria can be combined to further improve robustness. Using these concepts, the size of the video file (or the number of bits required in a transmission of the video signals) can be reduced since the visual effects of artifacts associated with the reduced file size can be reduced. Some of the concepts discussed herein are analogous to an artist first painting an entire picture with a spatially-smoothed Canvas (usually using a large broad brush) and then over-painting the Canvas with the required detail (usually using a small fine brush).

One embodiment of a method to perform these concepts consists of three parts with respect to image frames of the video signal:
1. A process to identify a Deblock region (DEB) that distinguishes the Deblock region from a so-called Detail region (DET);
2. An operation applied to the Deblock region DEB for the purposes of attenuating (smoothing) the appearance of block artifacts in the Deblock Region; and
3. A process to combine the now smoothed Deblock region obtained in part 2 with the Detail Region.

In the method of this embodiment the spatial-smoothing operation does not operate outside of the Deblock Region: equivalently, it does not operate in the Detail Region. As will be discussed herein, methods are employed to determine that the spatial-smoothing operation has reached the boundaries of the Deblock region DEB so that smoothing does not occur outside of the Deblock Region.

Video signals that have been previously subjected to block-based types of video compression (e.g. DCT-based compression) and decompression, and possibly to re-sizing and/or reformatting and/or color re-mixing, typically contain visibly-objectionable residues of block artifacts that first occurred during previous compression operations. Therefore, the removal of block-induced artifacts cannot be completely achieved by attenuating the appearance of only those blocks that were created in the last or current compression operation.

In many cases, a priori information about the locations of these previously created blocks is unavailable and blocks at unknown locations often contribute to objectionable artifacts. Embodiments of this method identify the region to be de-blocked by means of criteria that do not require a priori knowledge of the locations of the blocks.

In one embodiment, a flatness-of-intensity criteria method is employed and intensity-discontinuity criteria and/or intensity-gradient criteria is used to identify the Deblock region of each video frame which is to be de-blocked without specifically finding or identifying the locations of individual blocks. The Deblock region typically consists, in each frame, of many unconnected sub-regions of various sizes and shapes. This method only depends on information within the image frame to identify the Deblock region in that image frame. The remaining region of the image frame, after this identification, is defined as the Detail region.

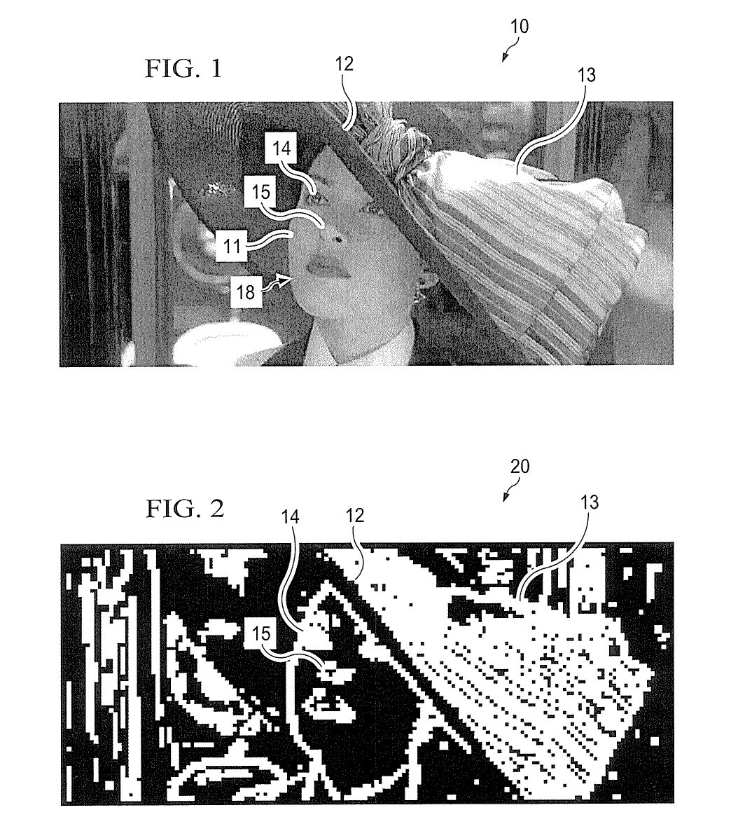

Video scenes consist of video objects. These objects are typically distinguished and recognized (by the HVS and the associated neural responses) in terms of the locations and motions of their intensity-edges and the texture of their interiors. For example, FIG. 1 shows a typical image frame 10 that contains visibly-objectionable block artifacts that appear similarly in the corresponding video clip when displayed in real-time. Typically within fractions of a second, the HVS perceives and recognizes the original objects in the corresponding video clip. For example, the face object 101 and its sub-objects, such as eyes 14 and nose 15, are quickly identified by the HVS along with the hat, which in turn contains sub-objects, such as ribbons 13 and brim 12. The HVS recognizes the large open interior of the face as skin texture having very little detail and characterized by its color and smooth shading.

While not clearly visible in the image frame of FIG. 1, but clearly visible in the corresponding electronically displayed real-time video signal, the block artifacts have various sizes and their locations are not restricted to the locations of the blocks that were created during the last compression operation. Attenuating only the blocks that were created during the last compression operation is often insufficient.

This method takes advantage of the psycho-visual property that the HVS is especially aware of, and sensitive to, those block artifacts (and their associated edge intensity-discontinuities) that are located in relatively large open areas of the image where there is almost constant intensity or smoothly-varying image intensity in the original image. For example, in FIG. 1, the HVS is relatively unaware of any block artifacts that are located between the stripes of the hat but is especially aware of, and sensitive to, the block artifacts that appear in the large open smoothly-shaded region of the skin on the face and also to block artifacts in the large open area of the left side (underneath of) the brim of the hat.

As another example of the sensitivity of the HVS to block artifacts, if the HVS perceives a video image of a uniformly-colored flat shaded surface, such as an illuminated wall, then block edge intensity-discontinuities of more than about 3% are visibly-objectionable whereas similar block edge intensity-discontinuities in a video image of a highly textured object, such as a highly textured field of blades of grass, are typically invisible to the HVS. It is more important to attenuate blocks in large open smooth-intensity regions than in regions of high spatial detail. This method exploits this characteristic of the HVS.

However, if the above wall is occluded from view except in small isolated regions, the HVS is again relatively unaware of the block artifacts. That is, the HVS is less sensitive to these blocks because, although located in regions of smooth-intensity, these regions are not sufficiently large. This method exploits this characteristic of the HVS. This method, at least in certain embodiments, exploits the psycho-visual property that the HVS is relatively unaware of block artifacts associated with moving objects if the speed of that motion is sufficiently fast.

As a result of applying this method to an image frame, the image is separated into at least two regions: the Deblock region and the remaining Detail region. The method can be applied in a hierarchy so that the above first-indentified Detail region is then itself separated into a second Deblock region and a second Detail region, and so on recursively.

FIG. 2 shows the result 20 of identifying the Deblock region (shown in black) and the Detail region (shown in white). The eyes 14, nose 15 and mouth belong to the Detail region (white) of the face object, as does most of the right-side region of the hat having the detailed texture of stripes. However, much of the left side of the hat is a region of approximately constant intensity and therefore belongs to the Deblock region while the edge of the brim 12 is a region of sharp discontinuity and corresponds to a thin line part of the Detail region.

As described in the following, criteria are employed to ensure that the Deblock region is the region in which the HVS is most aware of and sensitive to block artifacts and is therefore the region that is to be de-blocked. The Detail region is then the region in which the HVS is not particularly sensitive to block artifacts. In this method, deblocking of the Deblock region may be achieved by spatial intensity-smoothing. The process of spatial intensity-smoothing may be achieved by low pass filtering or by other means. Intensity-smoothing significantly attenuates the so-called high spatial frequencies of the region to be smoothed and thereby significantly attenuates the edge-discontinuities of intensity that are associated with the edges of block artifacts.

One embodiment of this method employs spatially-invariant low pass filters to spatially-smooth the identified Deblock Region. Such filters may be Infinite Impulse Response (IIR) filters or Finite Impulse Response (FIR) filters or a combination of such filters. These filters are typically low pass filters and are employed to attenuate the so-called high spatial frequencies of the Deblock region, thereby smoothing the intensities and attenuating the appearance of block artifacts.

The above definitions of the Deblock region DEB and the Detail region DET do not preclude further signal processing of either or both regions. In particular, using this method, the DET region could be subjected to further separation into new regions DET1 and DEB1 where DEB1 is a second region for Deblocking (DEB1εDET), possibly using a different Deblocking method or different filter than is used to deblock DEB. DEB1 and DET1 are clearly sub-regions of DET.

Identifying the Deblock region (DEB) often requires an identifying algorithm that has the capability to run video in real-time. For such applications, high levels of computational complexity (e.g., identifying algorithms that employ large numbers of multiply-accumulate operations (MACs) per second) tend to be less desirable than identifying algorithms that employ relatively few MACs/s and simple logic statements that operate on integers. Embodiments of this method use relatively few MACs/s. Similarly, embodiments of this method ensure that the swapping of large amounts of data into and out of off-chip memory is minimized. In one embodiment of this method, the identifying algorithm for determining the region DEB (and thereby the region DET) exploits the fact that most visibly-objectionable blocks in heavily compressed video clips have almost-constant intensity throughout their interiors.

In one embodiment of this method, the identification of the Deblock region DEB commences by choosing Candidate Regions Cᵢ in the frame. In one embodiment, these regions Cᵢ are as small as one pixel in spatial size. Other embodiments may use candidate regions Cᵢ that are larger than one pixel in size. Each Candidate region Cᵢ is tested against its surrounding neighborhood region by means of a set of criteria that, if met, cause Cᵢ to be classified as belonging to the Deblock region DEB of the image frame. If Cᵢ does not belong to the Deblock Region, it is set to belong to the Detail region DET. Note, this does not imply that the collection of all Cᵢ is equal to DEB, only that they form a sub-set of DEB.

In one embodiment of this method, the set of criteria used to determine whether Cᵢ belongs to the Deblock region DEB may be categorized as follows:
a. Flatness-of-Intensity Criteria (F),
b. Discontinuity Criteria (D) and
c. Look-Ahead/Look-Behind Criteria (L).

If the above criteria (or any useful combination thereof) are satisfied, the Candidate Regions Cᵢ are assigned to the Deblock region (i.e., CᵢεDEB). If not, then the Candidate Region Cᵢ is assigned to the Detail Region DET(CᵢεDET). In a particular implementation, such as when Deblocking a particular video clip, all three types of criteria (F, D and L) may not be necessary. Further, these criteria may be adapted on the basis of the local properties of the image frame. Such local properties might be statistical or they might be encoder/decoder-related properties, such as the quantization parameters or motion parameters used as part of the compression and decompression processes.

In one embodiment of this method, the Candidate Regions Cᵢ are chosen, for reasons of computational efficiency, such that they are sparsely-distributed in the image frame. This has the effect of significantly reducing the number of Candidate Regions Cᵢ in each frame, thereby reducing the algorithmic complexity and increasing the throughput (i.e., speed) of the algorithm.

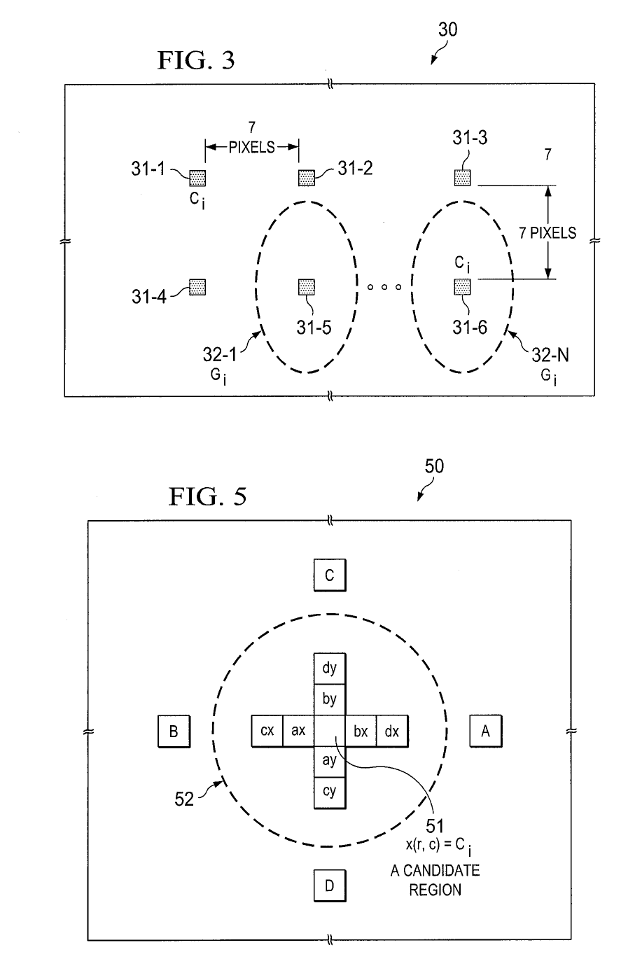

FIG. 3 shows, for a small region of the frame, the selected sparsely-distributed pixels that can be employed to test the image frame of FIG. 1 against the criteria. In FIG. 3, the pixels 31-1 to 31-6 are 7 pixels apart from their neighbors in both the horizontal and vertical directions. These pixels occupy approximately 1/64^{th} of the number of pixels in the original image, implying that any pixel-based algorithm that is used to identify the Deblock region only operates on 1/64^{th} of the number of pixels in each frame, thereby reducing the complexity and increasing the throughput relative to methods that test criteria at every pixel.

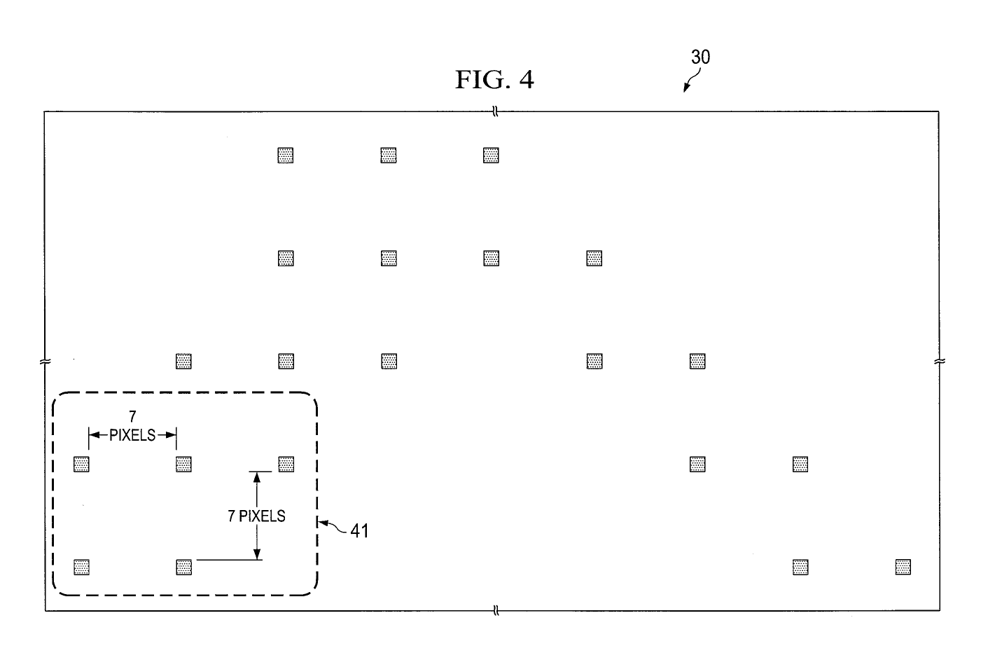

In this illustrative example, applying the Deblocking criteria to FIG. 1 to the sparsely-distributed Candidate region in FIG. 3 results in the corresponding sparsely-distributed CᵢεDEB as illustrated in FIG. 4.

In one embodiment of this method, the entire Deblock region DEB is ‘grown’ from the abovementioned sparsely-distributed Candidate Regions CᵢεDEB into surrounding regions.

The identification of the Deblock region in FIG. 2, for example, is ‘grown’ from the sparsely-distributed Cᵢ in FIG. 4 by setting N to 7 pixels, thereby ‘growing’ the sparse-distribution of Candidate region pixels Cᵢ to the much larger Deblock region in FIG. 2 which has the property that it is more contiguously connected.

The above growing process spatially connects the sparsely-distributed CᵢεDEB to form the entire Deblock region DEB.

In one embodiment of this method, the above growing process is performed on the basis of a suitable distance metric that is the horizontal or vertical distances of a pixel from the nearest Candidate region pixel Cᵢ. For example, with Candidate region pixels Cᵢ chosen at 7 pixels apart in the vertical and horizontal directions, the resultant Deblock region is as shown in FIG. 2.

As one enhancement, the growing process is applied to the Detail region DET in order to extend the Detail region DET into the previously determined Deblock region DEB. This can be used to prevent the crossed-mask of spatially invariant low-pass smoothing filters from protruding into the original Detail region and thereby avoid the possible creation of undesirable ‘halo’ effects. In doing so, the Detailed region may contain in its expanded boundaries unattenuated blocks, or portions thereof. This is not a practical problem because of the relative insensitivity of the HVS to such block artifacts that are proximate to Detailed Regions. An advantage of using the Expanded Detail Regions is that it more effectively covers moving objects having high speeds, thereby allowing the Key frames to be spaced farther apart for any given video signal. This, in turn, improves throughput and reduces complexity.

Alternate distance metrics may be employed. For example, a metric corresponding to all regions of the image frame within circles of a given radius centered on the Candidate Regions Cᵢ may be employed.

The Deblock Region, that is obtained by the above or other growing processes has the property that it encompasses (i.e. spatially covers) the part of the image frame that is to be deblocked.

Formalizing the above growing process, the entire Deblock region DEB (or the entire Detail region DET) can be determined by surrounding each Candidate Region Cᵢ (that meets the criteria CᵢεDEB or CᵢεDET) by a Surrounding Grown region Gᵢ whereupon the entire Deblock region DEB (or the entire Detail region DET) is the union of all Cᵢ and all Gᵢ.

Equivalently, the entire Deblock region can be written logically as

$$DEB = {⋃}_{i} ( ( {C}_{i} ∉ DET ) ⋃ {G}_{i} ) = {⋃}_{i} ( ( {C}_{i} ∈ DEB ) ⋃ {G}_{i} )$$

where ∪ is the union of the regions and where again DET is simply the remaining parts of the image frame. Alternatively, the entire Detail region DET may be determined from the qualifying Candidate Regions (using Cᵢ∉DEB) according to

$$DET = {⋃}_{i} ( ( {C}_{i} ∉ DEB ) ⋃ {G}_{i} ) = {⋃}_{i} ( ( {C}_{i} ∈ DET ) ⋃ {G}_{i} )$$

If the Grown Surrounding Regions Gᵢ (32-1 to 32-N in FIG. 3) are sufficiently large, they may be arranged to overlap or touch their neighbors in such a way as to create a Deblock region DEB that is contiguous over enlarged areas of the image frame.

One embodiment of this method is illustrated in FIG. 5 and employs a 9-pixel crossed-mask for identifying Candidate region pixels Cᵢ to be assigned to the Deblock region or to the Detail region DET. In this embodiment, the Candidate Regions Cᵢ are of size 1×1 pixels (i.e., a single pixel). The center of the crossed-mask (pixel 51) is at pixel x(r, c) where (r, c) points to the row and column location of the pixel where its intensity x is typically given by xε[0, 1, 2, 3, . . . 255]. Note that in this embodiment the crossed-mask consists of two single pixel-wide lines perpendicular to each other forming a+(cross). Any orientation of this “across” can be used, if desired.

Eight independent flatness criteria are labeled in FIG. 5 as ax, bx, cx, dx, ay, by, cy and dy and are applied at the 8 corresponding pixel locations. In the following, discontinuity (i.e., intensity-gradient) criteria are applied inside crossed-mask 52 and optionally outside of crossed-mask 52.

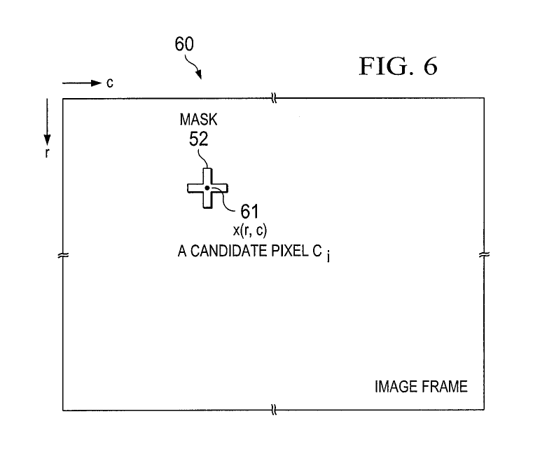

FIG. 6 shows an example of the nine pixel crossed-mask 52 used at a particular location within image frame 60. Crossed-mask 52 is illustrated for a particular location and, in general, is tested against criteria at a multiplicity of locations in the image frame. For a particular location, such as location 61 of image frame 60, the center of the crossed-mask 52 and the eight flatness-of-intensity criteria ax, bx, cx, dx, ay, by, cy and dy are applied against the criteria.

The specific identification algorithms used for these eight flatness criteria can be among those known to one of ordinary skill in the art. The eight flatness criteria are satisfied by writing the logical notations axεF, bxεF, . . . , dyεF. If met, the corresponding region is ‘sufficiently-flat’ according to whatever flatness-of-intensity criterion has been employed.

The following example logical condition may be used to determine whether the overall flatness criterion for each Candidate Pixel x(r,c) is satisfied: if

(axεF and bxεF) or (cxεF and dxεF) (1)

and

(ayεF and byεF) or (cyεF and dyεF) (2)

then

CᵢεFlat.

Equivalently, the above Boolean statement results in the truth of the statement CᵢεFlat under at least one of the following three conditions:
a) Crossed-mask 52 lies over a 9-pixel region that is entirely of sufficiently-flat intensity, therefore including sufficiently-flat regions where 52 lies entirely in the interior of a block
OR
b) Crossed-mask 52 lies over a discontinuity at one of the four locations

(r+1,c) OR (r+2,c) OR (r−1,c) OR (r−2,c)
while satisfying the flatness criteria at the remaining three locations
OR
c) Crossed-mask 52 lies over a discontinuity at one of the four locations

(r,c+1) OR (r,c+2) OR (r,c−1) OR (r,c−2)
while satisfying the flatness criteria at the remaining three locations.

In the above-described process, as required for identifying Candidate pixels, crossed-mask 52 spatially covers the discontinuous boundaries of blocks, or parts of blocks, regardless of their locations, while maintaining the truth of the statement CᵢεFlat.

A more detailed explanation of the above logic is as follows. Condition a) is true when all the bracketed statements in (1) and (2) are true. Suppose there exists a discontinuity at one of the locations given in b). Then statement (2) is true because one of the bracketed statements is true. Suppose there exists a discontinuity at one of the locations given in c). Then statement (1) is true because one of the bracketed statements is true.

Using the above Boolean logic, the flatness criterion is met when the crossed-mask 52 straddles the discontinuities that delineate the boundaries of a block, or part of a block, regardless of its location.

The employment of a specific algorithm for determining the Flatness Criteria F (that are applied to the Candidate Pixels Cᵢ) is not crucial to the method. However, to achieve high throughput capability, one example algorithm employs a simple mathematical flatness criterion for ax, bx, cx, dx, ay, by, cy and dy that is, in words, ‘the magnitude of the first-forward difference of the intensities between the horizontally adjacent and the vertically adjacent pixels’. The first-forward difference in the vertical direction, for example, of a 2D sequence x(r, c) is simply x(r+1, c)−x(r, c).

The above discussed flatness criteria are sometimes insufficient to properly identify the region DEB in every region of every frame for every video signal. Assume now that the above flatness condition CᵢεFlat is met for the Candidate Pixel at Cᵢ. Then, in this method, a Magnitude-Discontinuity Criterion D may be employed to improve the discrimination between a discontinuity that is part of a boundary artifact of a block and a non-artifact discontinuity that belongs to desired detail that exists in the original image, before and after its compression.

The Magnitude-Discontinuity Criterion method sets a simple threshold D below which the discontinuity is assumed to be an artifact of blocking. Writing the pixel x(r, c) (61) at Cᵢ in terms of its intensity x, the Magnitude Discontinuity Criterion is of the form

dx<D

where dx is the magnitude of the discontinuity of intensity at the center (r, c) of crossed-mask 52.

The required value of D can be inferred from the intra-frame quantization step size of the compression algorithm, which in turn can either be obtained from the decoder and encoder or estimated from the known compressed file size. In this way, transitions in the original image that are equal to or larger than D are not mistaken for the boundaries of blocking artifacts and thereby wrongly Deblocked. Combining this condition with the flatness condition gives a more stringent condition.

Values for D ranging from 10% to 20% of the intensity range of x(r, c) have been found to yield satisfactory attenuation of block artifacts over a wide range of different types of video scenes.

CᵢεFlat and dx<D

There will almost certainly exist non-artifact discontinuities (that should therefore not be deblocked) because they were in the original uncompressed image frame. Such non-artifact discontinuities may satisfy dx<D and may also reside where the surrounding region causes CᵢεFlat, according to the above criterion, which thereby leads to such discontinuities meeting the above criterion and thereby being wrongly classified for deblocking and therefore wrongly smoothed. However, such non-artifact discontinuities correspond to image details that are highly localized. Experiments have verified that such false deblocking is typically not objectionable to the HVS. However, to significantly reduce the probability of such rare instances of false deblocking, the following Look-Ahead (LA) and Look-Behind (LB) embodiment of the method may be employed.

It has been found experimentally that, in particular video image frames, there may exist a set of special numerical conditions under which the required original detail in the original video frame meets both of the above local flatness and local discontinuity conditions and would therefore be falsely identified (i.e., subjected to false deblocking and false smoothing). Equivalently, a small proportion of the Cᵢ could be wrongly assigned to DEB instead of to DET. As an example of this, a vertically-oriented transition of intensity at the edge of an object (in the uncompressed original image frame) can meet both the flatness conditions and the discontinuity conditions for deblocking. This can sometimes lead to visibly-objectionable artifacts in the displayed corresponding real-time video signal.

The following LA and LB criteria are optional and address the above special numerical conditions. They do so by measuring the change in intensity of the image from crossed-mask 52 to locations suitably located outside of crossed-mask 52.

If the above criteria CᵢεFlat and dx<D are met and also exceed a ‘looking ahead LA’ threshold criterion or a ‘looking back LB’ threshold criterion L, then the candidate Cᵢ pixel is not assigned to the Deblock Region. In terms of the magnitudes of derivatives, one embodiment of the LA and LB criteria is:

if

(dxA≧L) OR (dxB≧L) OR (dxC≧L) OR (dxD≧L)

then

Cᵢ∉DEB

In the above, terms such as (dxA≧L) simply mean that the magnitude of the LA magnitude-gradient or change criterion dx as measured from the location (r,c) out to the location of pixel A in this case is greater than or equal to the threshold number L. The other three terms have similar meanings but with respect to pixels at locations B, C and D.

The effect of the above LA and LB criteria is to ensure that deblocking cannot occur within a certain distance of an intensity-magnitude change of L or greater.

These LA and LB constraints have the desired effect of reducing the probability of false deblocking. The LA and LB constraints are also sufficient to prevent undesirable deblocking in regions that are in the close neighborhoods of where the magnitude of the intensity gradient is high, regardless of the flatness and discontinuity criteria.

An embodiment of the combined criteria, obtained by combining the above three sets of criteria, for assigning a pixel at Cᵢ to the Deblock region DEB, can be expressed as an example criterion as follows:

if

CᵢεFlat AND x<D AND ((dxA<L AND dxB<L AND dxC<L AND dxD<L))

then

CᵢεDEB

As an embodiment of this method, the truth of the above may be determined in hardware using fast logical operations on short integers. Evaluation of the above criteria over many videos of different types has verified its robustness in properly identifying the Deblock Regions DEB (and thereby the complementary Detail Regions DET).

Many previously-processed videos have ‘spread-out’ block edge-discontinuities. While being visibly-objectionable, spread-out block edge-discontinuities straddle more than one pixel in the vertical and/or horizontal directions. This can cause incorrect classification of block edge-discontinuities to the Deblock Region, as described by example in the following.

For example, consider a horizontal 1-pixel-wide discontinuity of magnitude 40 that separates flat-intensity regions that satisfy CᵢεFlat, occurring from say x(r, c )=100 to x(r, c+1)=140 with the criterion discontinuity threshold D=30. The discontinuity is of magnitude 40 and this exceeds D, implying that the pixel x(r,c) does not belong to the Deblock region DEB. Consider how this same discontinuity of magnitude 40 is classified if it is a spread-out discontinuity from say x(r, c)=100 to x(r, c+1)=120 to x(r, c+2)=140. In this case, the discontinuities at (r,c) and x(r,c+1) are each of magnitude 20 and because they fail to exceed the value of D, this causes false deblocking to occur: that is, both x(r,c) and x(r,c+1) would be wrongly assigned to the Deblock region DEB.

Similar spread-out edge discontinuities may exist in the vertical direction.

Most commonly, such spread-out discontinuities straddle 2 pixels although the straddling of 3 pixels is also found in some heavily-compressed video signals.

One embodiment of this method for correctly classifying spread-out edge-discontinuities is to employ a dilated version of the above 9-pixel crossed-mask 52 which may be used to identify and thereby deblock spread-out discontinuity boundaries. For example, all of the Candidate Regions identified in the 9-pixel crossed-mask 52 of FIG. 5 are 1 pixel in size but there is no reason why the entire crossed-mask could not be spatially-dilated (i.e. stretched), employing similar logic. Thus, ax, bx, . . . etc. are spaced 2 pixels apart, and surround a central region of 2×2 pixels. The above Combined Pixel-Level Deblock Condition remains in effect and is designed such that CᵢεFlat under at least one of the following three conditions:
d) Crossed-mask 52 (M) lies over a 20-pixel region that is entirely of sufficiently-flat intensity, therefore including sufficiently-flat regions where M lies entirely in the interior of a block
OR
e) Crossed-mask 52 lies over a 2-pixel wide discontinuity at one of the four 1×2 pixel locations

(r+2:r+3,c) OR (r+4:r+5,c) OR (r−2:r−1,c) OR (r−4:r−3,c)
while satisfying the flatness criteria at the remaining three locations
OR
f) Crossed-mask 52 lies over a 2-pixel wide discontinuity at one of the four 2×1 pixel locations

(r,c+2:c+3) OR (r,c+4:c+5) OR (r,c−2:c−1) OR (r,c−4:c−3)
while satisfying the flatness criteria at the remaining three locations.

In this way, as required, the crossed-mask M is capable of covering the I-pixel-wide boundaries as well as the spread-out 2-pixel-wide boundaries of blocks, regardless of their locations, while maintaining the truth of the statement CᵢεFlat. The minimum number of computations required for the 20-pixel crossed-mask is the same as for the 9-pixel version.

There are many variations in the details by which the above flatness and discontinuity criteria may be determined. For example, criteria for ‘flatness’ could involve such statistical measures as variance, mean and standard deviation as well as the removal of outlier values, typically at additional computational cost and slower throughput. Similarly, qualifying discontinuities could involve fractional changes of intensity, rather than absolute changes, and crossed-masks M can be dilated to allow the discontinuities to spread over several pixels in both directions.

A particular variation of the above criteria relates to fractional changes of intensity rather than absolute changes. This is important because it is well known that the HVS responds in an approximately linear way to fractional changes of intensity. There are a number of modifications of the above method for adapting to fractional changes and thereby improving the perception of deblocking, especially in dark regions of the image frame. They include:
i. Instead of subjecting the image intensity x(r,c) directly to the flatness and discontinuity criteria as the Candidate Pixel Cᵢ, the logarithm of intensity Cᵢ=log_{b}(x(r,c)) is used throughout, where the base b might be 10 or the natural exponent e=2.718 . . . .
OR
ii. Instead of employing magnitudes of intensity differences directly, fractional differences are used directly as all or part of the criteria for flatness, discontinuities, look ahead and look back. For example, the flatness criteria may be modified from the absolute intensity threshold e in

|x(r+1,c)−x(r,c)|<e
to a threshold containing a relative intensity term, such as a relative threshold e_{R} of the form

$${e}_{R} ≡ ( e + \frac{x ( r , c )}{{I}_{MAX}} )$$

where, in the example in the Appendix, we have used e=3 and I_{MAX}=255 which is the maximum intensity that can be assumed by x(r,c).

The Candidate Regions Cᵢ must sample the 2D space of the image frame sufficiently-densely that the boundaries of most of the block artifacts are not missed due to under-sampling. Given that block-based compression algorithms ensure that most boundaries of most blocks are separated by at least 4 pixels in both directions, it is possible with this method to sub-sample the image space at intervals of 4 pixels in each direction without missing almost all block boundary discontinuities. Up to 8 pixels in each direction has also been found to work well in practice. This significantly reduces computational overhead. For example sub-sampling by 4 in each direction leads to a disconnected set of points that belong to the Deblock Region. An embodiment of this method employs such sub-sampling.

Suppose the Candidate Pixels are L pixels apart in both directions. Then the Deblock region may be defined, from the sparsely-distributed Candidate Pixels, as that region obtained by surrounding all Candidate Pixels by L×L squares blocks. This is easy to implement with an efficient algorithm.

Once the Deblock Regions are identified, there is a wide variety of Deblocking strategies that can be applied to the Deblock region in order to attenuate the visibly-objectionable perception of blockiness. One method is to apply a smoothing operation to the Deblock Region, for example by using Spatially-Invariant Low Pass IIR Filters or Spatially-Invariant Low Pass FIR Filters or FFT-based Low Pass Filters.

An embodiment of this method down samples the original image frames prior to the smoothing operation, followed by up sampling to the original resolution after smoothing. This embodiment achieves faster overall smoothing because the smoothing operation takes place over a smaller number of pixels. This results in the use of less memory and fewer multiply accumulate operations per second MACs/s because the smoothing operation is applied to a much smaller (i.e. down-sampled) and contiguous image.

With the exception of certain filters such as the Recursive Moving Average (i.e. the Box) 2D filter, 2D FIR filters have computational complexity that increases with the level of smoothing that they are required to perform. Such FIR smoothing filters require a number of MACs/s that is approximately proportional to the level of smoothing.

Highly-compressed videos (e.g. having a quantization parameter q>40) typically require FIR filters of order greater than 11 to achieve sufficient smoothing effects, corresponding to at least 11 additions and up to 10 multiplications per pixel. A similar level of smoothing can be achieved with much lower order IIR filters, typically of order 2. One embodiment of this method employs IIR filters for smoothing the Deblock Region.

Another method for smoothing is similar to that described above except that the smoothing filters are spatially-varied (i.e., spatially-adapted) in such a way that the crossed-mask of the filters is altered, as a function of spatial location, so as not to overlap the Detail Region. In this method, the order (and therefore the crossed-mask size) of the filter is adaptively reduced as it approaches the boundary of the Detail Region.

The crossed-mask size may also be adapted on the basis of local statistics to achieve a required level of smoothing, albeit at increased computational cost. This method employs spatially-variant levels of smoothing in such a way that the response of the filters cannot overwrite (and thereby distort) the Detail region or penetrate across small Detail Regions to produce an undesirable ‘halo’ effect around the edges of the Detail Region.

A further improvement of this method applies a ‘growing’ process to the Detail region DET in a) above for all Key Frames such that DET is expanded around its boundaries. The method used for growing, to expand the boundaries, such as that described herein may be used, or other methods known to one of ordinary skill in the art. The resultant Expanded Detail region EXPDET is used in this further improvement as the Detail region for the adjacent image frames where it overwrites the Canvas Images CAN of those frames. This increases throughput and reduces computational complexity because it is only necessary to identify the Detail region DET (and its expansion EXPDET) in the Key Frames. The advantage of using EXPDET instead of DET is that EXPDET more effectively covers moving objects having high speeds than can be covered by DET. This allows the Key Frames to be spaced farther apart, for a given video signal, and thereby improves throughput and reduces complexity.

In this method, the Detailed region DET may be expanded at its boundaries to spatially cover and thereby make invisible any ‘halo’ effect that is produced by the smoothing operation used to deblock the Deblock region.

In an embodiment of this method, a spatially-variant 2D Recursive Moving Average Filter (i.e. a so-called 2D Box Filter) is employed, having the 2D Z transform transfer functions

$$H ( {z}_{1} , {z}_{2} ) = \frac{( 1 - {z}_{1}^{- {L}_{1}} ) ( 1 - {z}_{2}^{- {L}_{2}} )}{( 1 - {z}_{1}^{- 1} ) ( 1 - {z}_{2}^{- 1} )} \frac{1}{{L}_{1} {L}_{2}}$$

which facilitates fast recursive 2D FIR filtering of 2D order (L₁, L₂). The corresponding 2D recursive FIR input-output difference equation is

$$y ( r , c ) = y ( r - 1 , c ) + y ( r , c - 1 ) - y ( r - 1 , c - 1 ) + …$$

$$\frac{1}{{L}_{1} {L}_{2}} [ x ( r , c ) + x ( r - {L}_{1} , c ) + x ( r , c - {L}_{2} ) + x ( r - {L}_{1} , c - {L}_{2} ) ]$$

where y is the output and x is the input. This embodiment has the advantage that the arithmetic complexity is low and is independent of the level of smoothing.

In a specific example of the method, the order parameters (L₁, L₂) are spatially-varied (i.e., spatiality of the above 2D FIR Moving Average filter is adapted to avoid overlap of the response of the smoothing filters with the Detail region DET.

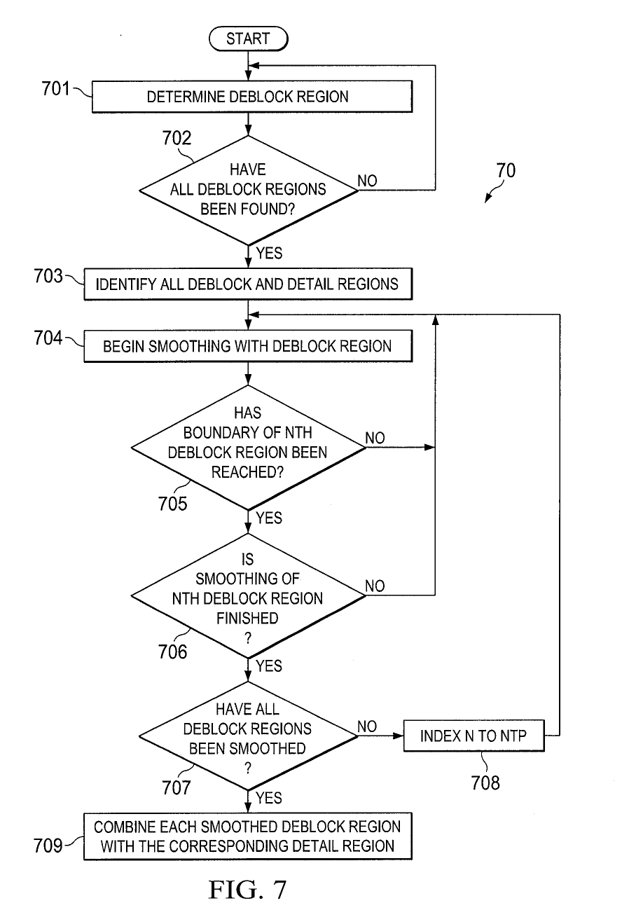

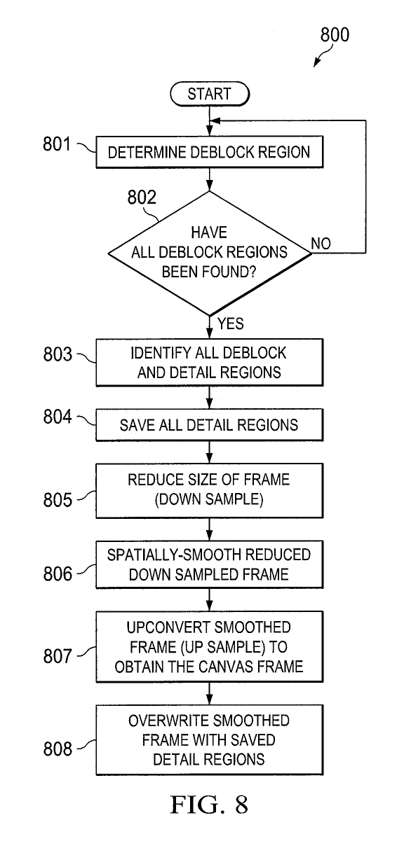

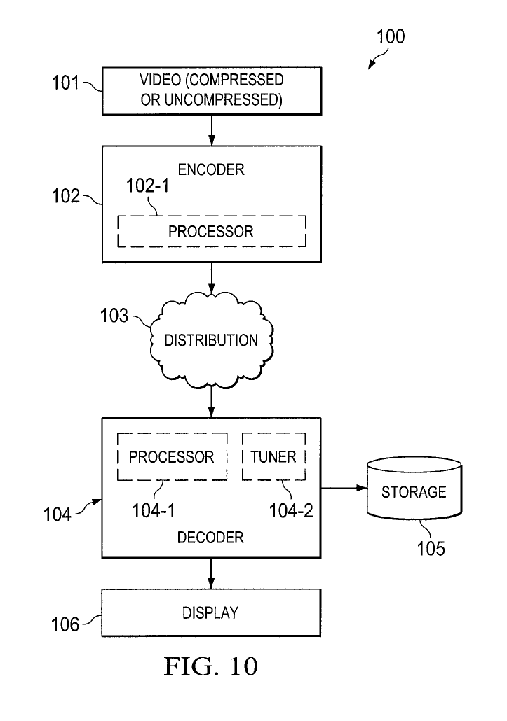

FIG. 7 shows one embodiment of a method, such as method 70, for achieving improved video image quality using the concepts discussed herein. One system for practicing this method can be, for example, by software, firmware, or an ASIC running in system 800 shown in FIG. 8, perhaps under control of processor 102-1 and/or 104-1 of FIG. 10. Process 701 determines a Deblock region. When all Deblock regions are found, as determined by process 702, process 703 can then identify all Deblock regions and by implication all Detail regions.

Process 704 can then begin smoothing such that process 705 determines when the boundary of the Nth Deblock region has been reached and process 706 determines when smoothing of the Nth region has been completed. Process 708 indexes the regions by adding 1 to the value N and processes 704 through 707 continue until process 707 determines that all Deblock regions have been smoothed. Then process 709 combines the smoothed Deblock regions with the respective Detail regions to arrive at an improved image frame. Note that it is not necessary to wait until all of the Deblock regions are smoothed before beginning the combining process since these operations can be performed in parallel if desired.

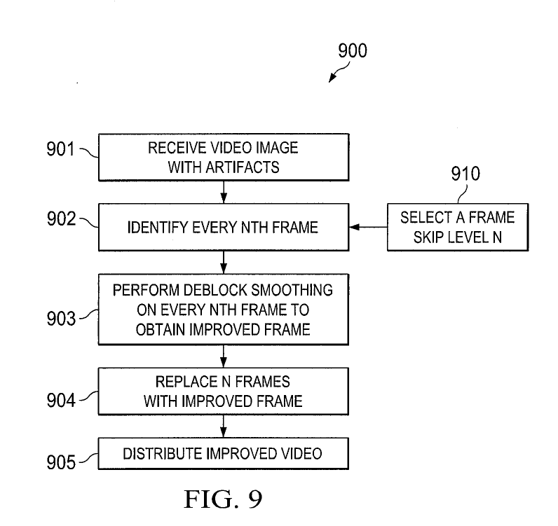

FIGS. 8 and 9 show one embodiment of a method operating according to the concepts discussed herein. Process 800 begins when a video frame is presented to process 801 which determines a first Deblock (or Detail) region. When processes 802 and 803 determine that all Deblock (or Detail) regions have been determined then process 804 saves the Detail regions. Process 805, which is optional, down-samples the video frame and process 806 smoothes the entire frame whether it is down-sampled or not. Down-sampling the frame results in the use of less memory and fewer MACs/s because the smoothing operation is applied to a much smaller (i.e. down-sampled) and contiguous image. This also results in less processing being required for the smoothing, thereby improving overall computational efficiency.

If the frame had been down-sampled then process 807 up-samples the frame to full resolution and process 808 then overwrites the smoothed frame with the saved Detail regions.

In other embodiments, as discussed with respect to process 900, FIG. 9, the Detail region is only determined in Key Frames, such as, for example, in every fourth frame. This can significantly improve the overall computational efficiency of the method. Thus, as shown in FIG. 9, in video scenes in which the motions of objects in adjacent frames have sufficiently low speeds, as is often the case, the Detail region is not identified for groups of adjacent non-Key Frames and, instead, the Detail region of the nearest key frame is overwritten on to the Canvas frame. Thus, process 901 receives the video frames and process 902 identifies every Nth frame. The number N can vary from time to time and, if desired, is controlled by the relative movement, or other factors, in the video image. Process 910 can control the selection of N.

Process 903 performs smoothing of every Nth frame and then process 904 replaces N frames with the Details saved from one frame. Process 905 then distributes the improved video frames for storage or display as desired.

In another embodiment, a ‘growing’ process is applied to the Detail region DET for all Key Frames, causing the Detail region to be expanded into a border around its boundaries, resulting in an Expanded Detail Region EXPDET. The advantage of using the Expanded Detail Region EXPDET is to more effectively cover moving objects having high speeds, thereby allowing the Key Frames to be spaced farther apart, for any given video signal. This, in turn, further improves throughput and reduces complexity.

Either the method for ‘growing’ described above or the more deliberate method described previously may be used in embodiments of the present invention. When the growing method is used, however, the resultant Expanded Detail Region EXPDET can be used in place of the Detail Region for the adjacent image frames where it overwrites the Canvas Images of those frames. This can increase throughput and reduce computational complexity because one can identify the Detail Region DET (and its expansion EXPDET) in the Key Frames instead of in every frame. One advantage of using EXPDET instead of DET is that EXPDET more effectively covers moving objects having high speeds than can be covered by DET. This can allow the key frames to be spaced farther apart, for a given video signal, and thereby improve throughput and reduce complexity.

The Canvas Method may fail to attenuate some block artifacts in the non-key frames if they are close to the boundaries of DET regions. This is because DET (or EXPDET, if used) from the Key Frame may fail to accurately align with the true DET region in the non-key frames. However, these unattenuated blocks at the boundaries of DET or EXPDET regions in non-Key Frames are typically not visibly-objectionable because:

1. The HVS is far more sensitive to (i.e., more aware of) block artifacts that occur in relatively large open connected regions of an image frame than it is aware of similar blocks that lie close to the boundaries of the Detail Region DET. This limitation of the HVS provides a psycho-visual attenuating real-time effect for the typical viewer.

2. The inter-frame motion of most objects over most video frames is sufficiently low that the Detail Region DET in key frame n covers a very similar region of the frame as it covers in adjacent non-key frames, such as n−1, n−2, n−3, n+1, n+2, n+3, because the motion of objects are temporally-smooth in the original video signal.

3. The psycho-visual attenuating effect in 1. is especially evident in the vicinity of those parts of the Detail Region DET that are undergoing motion and, further, the higher the speed of that motion the less the HVS is sensitive to the blocks that lie close to the region DET. It is a psycho-visual property of the HVS that the HVS is typically unaware of block artifacts that surround the boundaries of fast moving objects.

Experiments have confirmed that, for frame sequences having motion vectors corresponding to speeds of typically not more than 10 pixels per frame, the Key Frames may be at least as sparse as one Key Frame for every four frames of the original video sequence. Recall from the above that the smoothing to obtain the Canvas frame may also take place at low spatial resolution when applied to the down-sampled image frame.

Deblocking of the down sampled image may be at typically 1/16th or 1/64th of the original spatial resolution and at less than ¼ of the original temporal resolution, representing a computational savings of a factor of up to 64×4=256, relative to smoothing the original image to obtain the Canvas image at its full spatio-temporal resolution. The disadvantages of these spatio-temporal down sampling improvements are the need for spatial up-sampling and the possibility of visible block artifacts for high motion objects. The latter disadvantage may be eliminated by using motion vector information to adapt the extent of the spatial and temporal down-sampling.

FIG. 10 shows one embodiment 1000 of the use of the concepts discussed herein. In system 1000 video (and audio) is provided as an input 1001. This video can come from local storage, not shown, or received from a video data stream(s) from another location. This video can arrive in many forms, such as through a live broadcast stream, or video file and may be pre-compressed prior to being received by encoder 1002. Encoder 1002, using the processes discussed herein processes the video frames under control of processor 1002-1. The output of encoder 1002 could be to a file storage device (not shown) or delivered as a video stream, perhaps via network 1003, to a decoder, such as decoder 1004.

If more than one video stream is delivered to decoder 1004 then the various channels of the digital stream can be selected by tuner 1004-2 for decoding according to the processes discussed herein. Processor 1004-1 controls the decoding and the decoded output video stream can be stored in storage 1005 or displayed by one or more displays 1006 or, if desired, distributed (not shown) to other locations. Note that the various video channels can be sent from a single location, such as from encoder 1002, or from different locations, not shown. Transmission from the decoder to the encoder can be performed in any well-known manner using wireline or wireless transmission while conserving bandwidth on the transmission medium.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for removing artifacts from an image frame, said artifacts being visually disruptive to the HVS, said method comprising:
determining a Detail region of a digital representation of each image frame into a retained image frame;
retaining each said determined Detail region:
smoothing the entire original digital representation of each said image frame to create smoothed frames corresponding to each said image frame; and
overwriting each said smoothed image frame with said retained image frame.

2. The method of claim 1 wherein at least one of the following criteria is used for determining said Detail region: intensity-flatness; discontinuity; look-head; look-behind.

3. The method of claim 2 wherein parameters of said criteria are chosen such that artifact attenuation occurs for compressed image frames in which locations of artifact blocks are a priori unknown.

4. The method of claim 3 wherein said artifact blocks occur in said compressed video frames due to one or more of the following: previously compressed multiple times; re-formatted image frames; color-mixed image frames; re-sized image frames.

5. The method of claim 3 wherein said intensity-flatness criteria employs statistical measures comprising a local variance and a local mean of intensities.

6. The method of claim 3 wherein intensity change criteria are based on fractional changes of intensity.

7. The method of claim 2 wherein said smoothing comprises:
attenuating blocks as well as other artifacts.

8. The method of claim 1 where said retaining, smoothing and combining occur within a DCT-based encoder.

9. The method of claim 8 wherein said smoothing comprises at least one of: FIR filters, IIR filters.

10. The method of claim 9 wherein said filters can be either spatially-variant or spatially invariant.

11. The method of claim 11 wherein said smoothing comprises:
at least one Moving Average FIR 2D Box filter.

12. The method of claim 1 wherein said determining comprises:
selecting candidate regions; and
determining on a selected candidate by selected candidate region basis whether a selected candidate region belongs to said Detail region according to certain criteria.

13. The method of claim 12 wherein said candidate regions are sparsely located in each image frame.

14. The method of claim 1 further comprising:
receiving at a device a plurality of digital video streams, each said stream having a plurality of said digital video frames; and wherein said obtaining comprises:
selecting one of said received digital video streams at said device.

15. The method of claim 1 wherein said smoothing comprises:
down-sampling said image frame prior to smoothing.

16. The method of claim 15 wherein said down-sampled image is spatially-smoothed.

17. The method of claim 16 where said smoothed image is up sampled to obtain full resolution prior to said combining.

18. The method of claim 1 wherein said Detail region is expanded beyond its boundaries so that it covers Detailed regions of adjacent frames.

19. The method of claim 18 wherein said expanded Detailed region is determined only in non-adjacent key frames spaced at least N frames apart.

20. The method of claim 19 where N is at least four frames.

21. The method of claim 19 wherein said Detail region from said key frames is used in adjacent non-key frames instead of a Detail region from said non-key frames.

22. The method of claim 1 wherein said Detailed region is determined only in non-adjacent key frames spaced at least N frames apart.

23. The method of claim 22 where N is at least four frames.

24. The method of claim 22 wherein said Detail region from said key frames is used in adjacent non-key frames instead of a Detail region from said non-key frames.

25. The method of claim 1 further comprising:
using additional information from a compression process used to compress said image frame to improve detection of said Detailed region, said additional information selected from the list of: motion vectors, quantization step sizes, the locations of blocks.

26. A system for presenting video, said system comprising:
an input for obtaining a first video frame having a certain number of bits per pixel; said certain number being such that when said video frame is presented to a display said display yields artifacts perceptible to a human visual system (HVS);
circuitry for producing a second video frame from said first video frame, said second video frame yielding artifacts less perceptible to said HVS when said second video frame is presented to said display; said circuitry comprising a processor for performing the functions of:
determining and retaining a Detail region of a digital representation of each image frame into a retained image frame;
smoothing the entire original digital representation of each said image frame to create smoothed frames corresponding to each said image frame; and
overwriting each said smoothed image frame with each said retained image frame.

27. The system of claim 26 further comprising:
a tuner for allowing a user to select one of a plurality of digital video streams, each said video stream comprising a plurality of digital video frames.

28. The system of claim 27 wherein said determining means comprises: processing using at least one of the following criteria for determining said Deblock Region: intensity-flatness; discontinuity; look-head; look-behind.

29. The system of claim 28 wherein parameters of said criteria are chosen such that artifact attenuation occurs for compressed image frames in which locations of artifact blocks are a priori unknown.

30. The system of claim 29 wherein said artifact blocks occur in said compressed video frames due to one or more of the following: previously compressed multiple times; re-formatted image frames; color-mixed image frames; re-sized image frames.

31. The system of claim 30 wherein said intensity-flatness criteria employs statistical measures comprising a local variance and a local mean of intensities.

32. The system of claim 30 wherein intensity change criteria are based on fractional changes of intensity.

33. The system of claim 26 where said processor is a portion of a DCT-based encoder.

34. The system of claim 26 wherein said determining means comprises:
means for selecting candidate regions; and
means for determining on a selected candidate by selected candidate region basis whether a selected candidate region belongs to said Detail region according to certain criteria.

35. The system of claim 34 wherein said candidate regions are sparsely located in each image frame.

36. The system of claim 26 wherein said smoothing comprises:
down-sampling said image frame prior to smoothing.

37. The system of claim 36 wherein said down-sampled image is spatially-smoothed.

38. The system of claim 36 further comprising:
means for up-sampling said smoothed image to obtain full resolution prior to said combining.

39. The system of claim 26 further comprising:
means for expanding said Detail region beyond its boundaries so that it covers Detailed regions of adjacent frames.

40. The system of claim 39 wherein said expanded Detailed region is determined only in non-adjacent key frames spaced at least N frames apart.

41. The system of claim 40 where N is at least four frames.

42. The system of claim 40 wherein said Detail region from said key frames is used in adjacent non-key frames instead of a Detail region from said non-key frames.

43. The system of claim 26 wherein said Detailed region is determined only in non-adjacent key frames spaced at least N frames apart.

44. The system of claim 43 where N is at least four frames.

45. The system of claim 43 wherein said Detail region from said key frames is used in adjacent non-key frames instead of a Detail region from said non-key frames.

46. The system of claim 26 further comprising:
means for using additional information from a compression process used to compress said image frame to improve detection of said Detailed region, said additional information selected from the list of: motion vectors, quantization step sizes, the locations of blocks.

47. A method of presenting video, said method comprising:
obtaining a first video frame having a certain number of bits per pixel; said certain number being such that when said video frame is presented to a display said display yields artifacts perceptible to a human visual system (HVS);
producing a second video frame from said first video frame, said second video frame yielding artifacts less perceptible to said HVS when said second video frame is presented to said display; wherein said producing comprises:
determining Detail regions within each said frame;
saving said determined Detail regions; and
smoothing the entirety of each said frame; and
combining each said smoothed frame with each said saved Detail region.

48. The method of claim 47 wherein said combining comprises:
overwriting each said smoothed frame with said saved Detail region.

49. The method of claim 48 further comprising:
receiving at a device a plurality of digital video streams, each said stream having a plurality of said digital video frames; and wherein said obtaining comprises:
selecting one of said received digital video streams at said device.

50. The method of claim 49 wherein said smoothing comprises:
down-sampling said image frame prior to smoothing.

51. The method of claim 50 wherein said down-sampled image is spatially-smoothed.

52. The method of claim 50 where said smoothed image is up-sampled to obtain full resolution prior to said combining.
